(19) United States
(12) Patent Application Publication
(10) Pub. No.: US 2004/0128458 A1
(43) Pub. Date: Jul. 1, 2004

(54) Method and device for protecting data transmission between a central processor and a memory

(76) Inventor: Wolfgang Buhr, Hamburg (DE)

Correspondence Address: Philips Electronics North America Corporation, Intellectual Property & Standards, Mail Stop SJ41, 1109 McKay Drive, San Jose, CA, 95131, US

(21) Appl. No.: 10/477,984

(22) PCT Filed: May 15, 2002
(86) PCT No.: PCT/IB02/01690

(30) Foreign Application Priority Data
May 17, 2001 (DE) 101 24 139.9

(51) Int. Cl. G06F 12/14

(52) U.S. Cl. 711/164; 711/203

(57) ABSTRACT

The invention relates to a method of dual-stage scrambling of addresses (LogAdr) with which a central processor (10) accesses a memory (13). A first encryption logic (11) applies a fixed, unchangeable key (KEY1), whereas a second encryption logic (12) applies a changeable second key (KEY2) stored in the memory (13). The configuration data written during the initialization phase of the central processor (10) are preferably stored in a special configuration range which is accessed via a bypass (15) while bypassing the second encryption logic (12). The bypass is activated by a bypass logic (14) which compares the addresses (Cipher 1) encrypted in the first stage with values (SecRowCipher1, SecRowCipher2) stored during the initialization phase.

### FIELD OF THE INVENTION

The invention relates to a method of protecting data transmission between a central processor and a memory, in which the logic addresses supplied by the central processor are encoded with a first, unchangeably stored key. The invention also relates to a data processing unit comprising a central processor which is connected to a store via address lines and data lines, and a first encryption logic arranged in the address lines which encodes the logic addresses supplied by the central processor with a first, unchangeably stored key.

### BACKGROUND OF THE INVENTION

There is a connection between a central processor and a memory in almost all data processing systems. To protect the data in the memory from abuse, it is known to store them in an encrypted form. A dynamic method of encrypting the data stored in a memory is described in, for example, U.S. Pat. No. 5,987,572. In this method, the data are encoded with a changeable key which, however, requires a considerable computation effort.

Moreover, encryption methods, particularly for smart cards are known. Smart cards are increasingly used as cheque cards, money cards, identity cards or the like as carriers of security-relevant data and have a non-volatile memory whose contents are also maintained after switching off the processor, or without any external current supply. In the known encryption methods for smart cards, the addresses of the memory are scrambled by means of a key stored in the hardware or permanently in ROM memories. This means that the logic addresses of a data supplied or used by the central processor are copied in a one-to-one relation by means of the key on another address under which the data is then physically present in the memory. It is true that this method is proportionally simple but it has the drawback that a scrambling once analyzed and decrypted is transferable to all systems of the same type or of the same ROM code. A single abusive decryption therefore jeopardizes the security of a multitude of smart cards. Furthermore, it is a drawback that the entire contents must be erased to make the memory contents unusable because data in the memory can always be retraced from the same (scrambled) address.

### OBJECT AND SUMMARY OF THE INVENTION

It is therefore an object of the present invention to provide a method and a data processing unit offering greater protection of the data in the memory associated with a central processor.

This object is solved by a method as defined in claim 1 and by a data processing unit as defined in claim 7. Advantageous embodiments are defined in the dependent claims.

The method is used for protecting data transmission between a central processor and a memory and particularly prevents the data in the memory from being read and used abusively. In the method, the logic addresses of data used and supplied by the central processor are encoded with a first, unchangeably stored key. This first key can be stored, for example, in a hardware configuration or in ROM memories (including EPROM, EEPROM, etc.). The method is further characterized in that at least a part of the addresses encoded with the first key is encoded a second time with a second, changeably stored key.

The second encryption of the addresses with a changeable key has the advantage that the data can be individually encrypted for each data processing system of this type by providing an individual second key. Even when the first encryption stage or the first key were deciphered in an abusive attack, the data could not be decoded by all systems of the same type with the same first key because these data are each time scrambled with a different, second key. The method thus provides a considerably greater protection of the data stored in the memory.

Moreover, the method also has the advantage that the contents of the memory can be made unusable by changing or overwriting the changeable second key. This is possible without having to erase the whole memory or overwrite it with random numbers.

In accordance with a further embodiment of the method, the memory is logically divided into a configuration range and a useful data range, in which the access to the configuration range is only encoded with the first key, whereas the access to the useful data range is additionally encoded with the second key. As the name “configuration range” already indicates, the data which are relevant for the configuration of the data processing system or the central processor are preferably stored in this range. In this way, the processor can have access without knowing or using the second key. This is particularly advantageous when initializing the central processor because the configuration data are then always found at the same site which is independent of the second key.

In a memory subdivided as described above, the second key is preferably stored in the configuration range. When the central processor is initialized, it can then be read from this range and subsequently be used for the second encoding operation. No additional memory is necessary for storing the second key, which is advantageous particularly in the case of smart cards.

In accordance with a further embodiment of the method, those logic addresses that, upon consecutive encoding with initially the first and then the second key, assume values which correspond to the addresses of the configuration range that have been encoded with the first key only, are encoded once more with the second key before access to the memory. This method has the following background. Since only the first key is used when the configuration range is stored in the memory, this range collides with addresses in the memory which, after encoding with both the first and the second key, are stored at the same site. To prevent this collision and thereby a loss of data, the second key is applied a second time to the last-mentioned addresses so that these addresses are passed on to those free sites that would have been assumed by the configuration range upon application of a first and a second encryption.

The encoding operations by means of the first and the second key are preferably defined in such a way that the identity is obtained in the case of dual application of the first encoding operation or dual application of the second encoding operation. Any encoding function thus simultaneously represents its own inverse value.

In accordance with a further embodiment of the invention, the second key and/or values from which addresses to be encoded with only the first key can be recognized are read or computed during the initialization of the central processor. The initialization phase of the central processor can thus proceed identically in all of its systems which are equal in their hardware and the permanently stored configurations, but individual data are generated and stored for each system during the initialization phase, which data subsequently ensure an individual encryption.

The invention also relates to a data processing unit comprising a central processor which is connected to a memory via address lines and data lines. The data processing unit also comprises a first encryption logic arranged in the address lines, which encodes the logic addresses supplied by the central processor with a first, unchangeably stored key. The data processing unit is characterized in that it comprises a second encryption logic arranged in the address lines, which encodes the addresses encoded with the first key at least partly a second time with a second, changeably stored key. Such a data processing unit may be particularly a smart card.

The data processing unit has the advantage that it allows an individual encryption or scrambling of data in the memory, independent of the second key. The abusive decryption of the first encryption logic with the first key thus does not automatically provide access to the data of all, similar data processing units. Each data processing unit would rather require the second key for such an access.

The data processing unit is further preferably designed or adapted in such a way that a method of the type described hereinbefore can be performed with this unit.

The data processing unit may particularly comprise a bypass logic which receives the (logic) addresses generated and/or used by the first encryption logic as input, and activates a bypass of the second encryption logic when these addresses correspond to predetermined values. By means of the bypass logic, the second encryption can thus be selectively switched off. This is particularly useful when applying a configuration range as described above, which should be encrypted with the first encryption logic only.

### BRIEF DESCRIPTION OF THE DRAWINGS

These and other aspects of the invention are apparent from and will be elucidated with reference to the embodiments described hereinafter.

In the drawings:

FIG. 1 shows diagrammatically the components of a data processing unit according to the invention;

FIG. 2 shows diagrammatically the addresses in different encryption stages.

### DESCRIPTION OF EMBODIMENTS

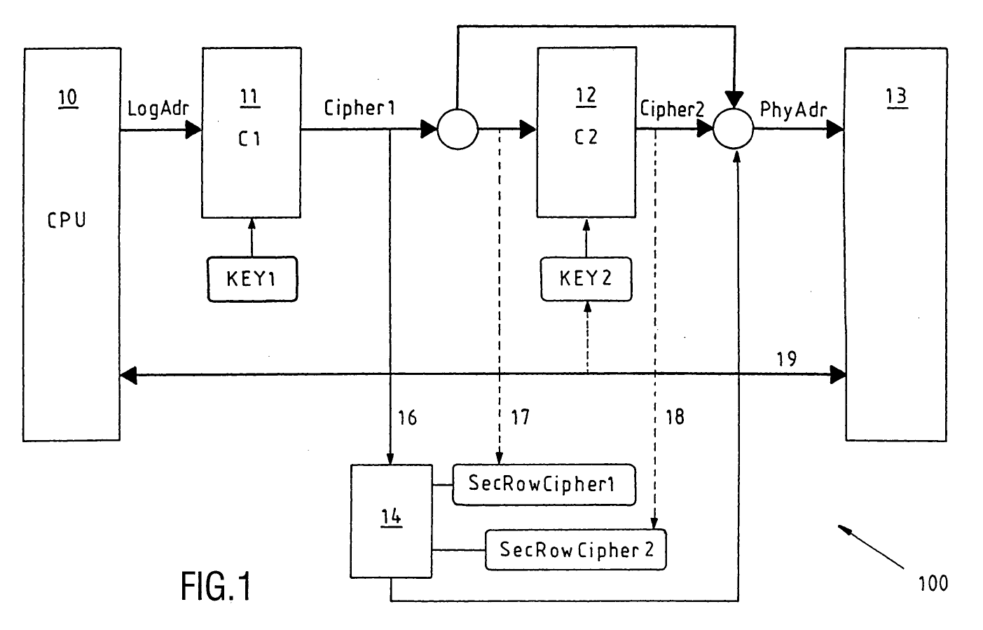

FIG. 1 shows the essential components of a data processing unit 100 comprising a central processor 10 and a memory module 13 connected thereto. The unit may be particularly a smart card 100 in which the memory 13 is a non-volatile memory storing, for reasons of costs, both program codes and data and control data and configuration parameters to be specially protected.

To protect the contents of the memory 13 from a physical analysis, it is known to encode the logic addresses LogAdr used by the central processor 10 and provided on the address lines via a first encryption logic 11. The logic addresses LogAdr are transformed as a one-to-one copy C1 to addresses “Cipher1” by means of a key KEY1 stored in the hardware configuration or in a ROM memory. The data or addresses transmitted via the data line 19 are thus scrambled before they are stored in the memory 13.

Since the known systems with only one encryption logic 11 using a fixed key KEY1 do not provide individual protection of the data in the memory 13, a second encryption logic 12 is arranged according to the invention in the address line between the first encryption logic 11 and the memory 13. The second encryption logic 12 uses a second key KEY2 for its one-to-one transformation C2. In contrast to the first key KEY1, this key is not fixed but is stored in a changeable form in the memory 13. The value of the second key KEY2 is read from the memory 13 during the initialization via the data line 19.

The sequential application of the first encryption C1 and the second encryption C2 thus ensures a scrambling of the addresses LogAdr to physical memory addresses PhyAdr in the memory 13 which can be predetermined individually via the second key KEY2 for each smart card 100.

During the initialization phase of the central processor 10, the second encryption logic 12 is preferably switched off in order that the configuration data of the central processor are always found at the same sites of the memory 13 predetermined by the first encryption logic 11 and the first key KEY1. Such a “fixed” location of the configuration range also provides the possibility of reading the second key KEY2 from the memory 13 only during the initialization so that it is subsequently available for the encryption logic 12.

To be able to access the configuration range in the memory module 13 while bypassing the second encryption logic 12, the data processing unit 110 comprises a bypass 15 which bypasses the second encryption logic 12, and a bypass logic 14 which can selectively switch the bypass 15 on and off. Via a line 16, the input of the bypass logic 14 receives the current address Cipher1 encrypted by means of the first encryption logic 11. This value is compared with the two stored values SecRowCipher1 and SecRowCipher2. In so far as Cipher1 is equal to one of the two stored values, the bypass logic 14 activates the bypass 15 so that the memory 13 is accessed while bypassing the second encryption logic 12.

The two above-mentioned stored addresses SecRowCipher1 and SecRowCipher2 are stored via the connection lines 17 and 18 during the initialization of the central processor 10. The initialization proceeds as follows.

Initially, the second encryption logic 12 stores the second key KEY2 read from the configuration range of the memory 13 during the initialization in a local memory. During the overall initialization phase, the bypass 15 is activated so that the memory 13 is accessed only via the first encryption logic 11 with the addresses PhyAdr=Cipher1. By the end of the initialization phase, the second encryption logic 12 then stores both the Cipher1 addresses of the configuration range generated with the first key KEY1 in accordance with SecRowCipher1 and the Cipher2 addresses of the configuration range generated with the second key KEY2 in accordance with SecRowCipher2. This is effected while the bypass 15 is activated.

After ending the initialization phase, the bypass 15 is then generally deactivated so as to basically apply scrambled codes C1 and C2 to the memory addresses LogAdr.

Only when the bypass logic 14 recognizes one of the two addresses SecRowCipher1 or SecRowCipher2 stored during the initialization phase as Cipher1 addresses at its input, does it activate the bypass 15 for this access so that the second encryption logic 12 is bypassed. The addresses of the configuration range are thus not affected by the second scrambling copy C2.

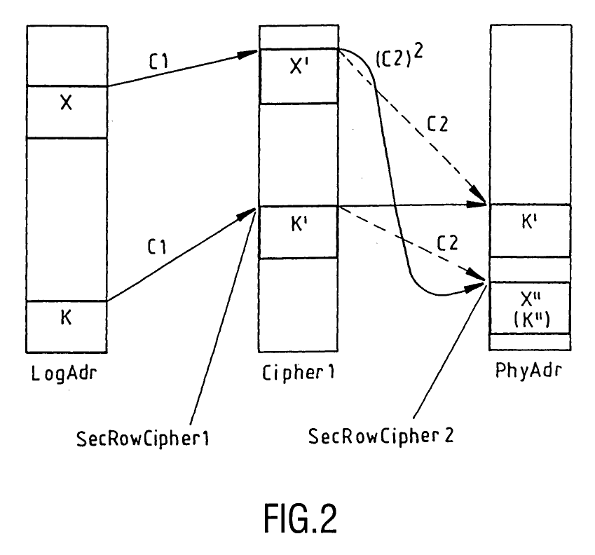

FIG. 2 diagrammatically shows the scrambled codes or copies of addresses in the data processing system 100 shown in FIG. 1.

The logic addresses LogAdr are first converted by the first encryption logic 11 with the copy C1 into an address Cipher1. By using the second encryption logic 12 with the copy C2 an address Cipher2, which is encrypted twice, is generated from each of these addresses Cipher1, which address Cipher2 indicates a physical memory location PhyAdr of the memory.

If the copies C1 and C2 were used consecutively for all logic addresses LogAdr, a one-to-one scrambling of these addresses in the address location PhyAdr of the memory would take place.

However, it is desirable for the reasons mentioned above to provide a configuration range K in the logic address location, which is copied to a range K′ in the memory only by means of the first scrambled code C1. This is achieved in the data processing unit 100 of FIG. 1 in that the bypass logic 14 ensures that the second encryption logic 12 is bypassed when it recognizes the C1-encrypted addresses of the configuration range, i.e. SecRowCipher1 at its input.

The range K′ of the memory, in which the configuration range K is copied by single application of the first encryption C1 would normally be occupied by another range X of the logic address location LogAdr due to the sequential application of the first encryption C1 and the second encryption C2. To prevent this collision, said range X is copied in the free range K″=X″ of the memory in which the configuration range K would be located upon sequential application of the first encryption C1 and the second encryption C2. This is effected in that the range X of the logic address location is copied by the first encryption C1 and a dual application of the second encryption (C2)².

The above-mentioned displacement of the range X is considerably simplified when the second encryption C2 is its own inverse so that the identity is obtained upon dual application. In this case, the dual application of the second encryption (C2)² can be dispensed with and the range X—likewise as the configuration range K—should be copied in the memory with the first encryption C1 only. The bypass logic 14 of the data processing unit 100 of FIG. 1 recognizes this situation in that the address SecRowCipher2 is present at its input, which address corresponds to the address of the configuration range K″ in the memory, obtained when applying the first encryption C1 and the second encryption C2 to the configuration range K.

The method shown by way of example with reference to the Figures has the advantage that the scrambling of user data can be changed any time, for example, when personalizing the memory 13 for the client, by programming the second key KEY2 in the configuration range so that it can be supplied individually. This makes efforts of abusive examination considerably more difficult because each system has its individual scrambled code which cannot be transferred to other systems. Moreover, each manipulation in the configuration range of the memory 13 changing the second key KEY2 leads to an immediate change of the scrambled code of the useful data range and hence to unusable user data, which is comparable with a memory initialization by means of random data. However, this additional scrambling mechanism for the useful data range does not affect the secure access to the configuration range of the memory 13 during the initialization phase.

Reference Signs:

100 data processing unit

10 central processor

11 first encryption logic

12 second encryption logic

13 memory

14 bypass logic

15 bypass

16 line

17, 18 initialization line

19 data line

LogAdr logic address

Cipher1 once encrypted address

Cipher2 twice encrypted address

KEY1, KEY2 keys

PhyAdr physical address

K configuration range

C1 first scrambled code

C2 second scrambled code

1. A method of protecting data transmission between a central processor (10) and a memory (13), in which the logic addresses (LogAdr) supplied by the central processor are encoded with a first, unchangeably stored key (KEY1), characterized in that at least a part of the addresses thus encoded is encoded a second time with a second, changeably stored key (KEY2).

2. A method as claimed in claim 1, characterized in that the memory (13) is logically divided into a configuration range (K) and a useful data range, in which the access to the configuration range is encoded only with the first key (KEY1), whereas the access to the useful data range is additionally encoded with the second key (KEY2).

3. A method as claimed in claim 2, characterized in that the second key (KEY2) is stored in the configuration range (K).

4. A method as claimed in any one of claims 1 to 3, characterized in that those logic addresses (X) that, upon sequential encoding (C1, C2) with the first and the second key (KEY1, KEY2), assume values which correspond to the addresses of the configuration range (K) encoded only with the first key (KEY1), are encoded (C2) once more with the second key (KEY2) before access to the memory (18).

5. A method as claimed in any one of claims 1 to 4, characterized in that the encoding (C1, C2) with the first and/or the second key (KEY1, KEY2) provides the identity upon dual application.

6. A method as claimed in any one of claims 1 to 5, characterized in that the second key (KEY2) and/or values (SecRowCipher1, SecRowCipher2) from which addresses to be encoded can be recognized with the first key (KEY1) only, are read or computed during initialization of the central processor (10).

7. A data processing unit (100) comprising a central processor (10) which is connected to a memory (13) via address lines and data lines (19), and a first encryption logic (11) arranged in the address lines which encodes the logic addresses supplied by the central processor with a first, unchangeably stored key (KEY1), characterized in that it comprises a second encryption logic (12) arranged in the address lines which encodes the addresses encoded with the first key (KEY1) at least partly a second time with a second, changeably stored key (KEY2).

8. A data processing unit as claimed in claim 7, characterized in that it is adapted in such a way that it can perform a method as claimed in any one of claims 1 to 6.

9. A data processing unit as claimed in claim 7 or 8, characterized in that it comprises a bypass logic (14) which receives the addresses (Cipher1) generated and/or used by the first encryption logic (11) as an input, and which activates a bypass (15) of the second encryption logic (12) when said addresses correspond to predetermined values (SecRowCipher1, SecRowCipher2).
